(19) United States
(12) Patent Application Publication
(10) Pub. No.: US 2025/0122101 A1
(43) Pub. Date: Apr. 17, 2025

(54) PROCESS AND SYSTEM FOR WATER TREATMENT IN OFFSHORE OIL PRODUCTION FACILITIES

(71) Applicants: PETRÓLEO BRASILEIRO S.A. - PETROBRAS, Rio de Janeiro (BR); UNIVERSIDADE FEDERAL DE SANTA CATARINA - UFSC, Florianópolis (BR)

(72) Inventors: Silvio EDEGAR WESCHENFELDER, Rio de Janeiro (BR); Adriano DA SILVA, Florianópolis (BR); Luciana PRAZERES MAZUR, Campinas (BR); Byron ROSEMBERG DOS SANTOS COSTA, Rio de Janeiro (BR)

(73) Assignees: PETRÓLEO BRASILEIRO S.A. - PETROBRAS, Rio de Janeiro (BR); UNIVERSIDADE FEDERAL DE SANTA CATARINA - UFSC, Florianópolis (BR)

(21) Appl. No.: 18/917,069

(22) Filed: Oct. 16, 2024

(30) Foreign Application Priority Data
Oct. 17, 2023 (BR) BR1020230215599

(51) Int. Cl. C02F 1/26; B01D 17/02; B01D 17/04; C02F 1/24; C02F 101/32; C02F 103/36

(52) U.S. Cl. CPC C02F 1/26; B01D 17/0214; B01D 17/0217; B01D 17/047; C02F 1/24; C02F 2101/32; C02F 2103/365; C02F 2209/06; C02F 2301/046

(57) ABSTRACT

The present invention relates to a process and system for water treatment in offshore oil production facilities, aiming at promoting the injection and mixing of acid and natural gas liquid (NGL), generated in the offshore facility itself, in the produced water stream to extract dissolved organic acids. The present invention describes different alternatives for promoting the mixing of these inputs in the produced water stream, being adaptable to equipment and units already in operation and without the need to acquire new chemical products and equipment.

### CROSS-REFERENCE TO RELATED APPLICATION

This application claims, under 35 U.S.C. § 119(a), priority to and the benefit of Brazilian Patent Application No. 10 2023 021559 9, filed Oct. 17, 2023, which is incorporated by reference herein in its entirety.

### FIELD OF THE INVENTION

The present invention pertains to the field of Sustainable Development and refers to a process and system for treating water in offshore oil production facilities.

### BACKGROUNDS OF THE INVENTION

The produced water generated during oil and gas exploration is one of the major challenges in the energy sector due to the large volumes generated daily and the potential harmful effects of the organic and inorganic constituents of the produced water on the ecosystem. This effluent contains a variety of inorganic salts, metals, radioisotopes and organic compounds, especially hydrocarbons, present in dissolved or dispersed form. Some organic compounds, due to their properties, are soluble in water and can be quantified by the analytical method currently required by IBAMA for verifying the oil and grease content (OGC) (Standard Methods-SM 5520B).

Although reuse and reinjection into producing reservoirs can reduce this problem, there is a continuous need for adequate treatment before discharge into the sea. For the disposal of produced water into the sea, Brazilian legislation, through Resolution CONAMA No. 393, stipulates that the OGC is a standard for the continuous release of produced water in oceanic regions, and cannot exceed the daily limits of 42 mg. L⁻¹ and the monthly limits of 29 mg. L⁻¹. This parameter represents the amount of oil, fats, waxes and, mainly, soluble organic compounds present in the effluent, including the aliphatic and aromatic hydrocarbons, phenols and dissolved organic acids (OGP, 2002; NEFF et al., 2011; ZHENG et al., 2016).

The increase in the flow rate of produced water over the exploration time contributes to a decrease in the efficiency of the treatment processes. Conventional separation methods currently used, such as hydrocyclone and floater, are often limited due to low separation efficiency, mainly of dissolved organic acids, which cannot meet the growing demand for larger extracted volumes of water. Consequently, the oil production is limited to the processing capacity of this effluent. In addition, international environmental legislation is constantly increasing the requirement for new contaminant controls and environmental impact indicators resulting from the discharge of produced water into the sea.

The environmental control standards for the North Sea already indicate the need to investigate several specific compounds such as BTEX, APHs and dissolved heavy metals, associating these discharge levels with the dynamics of sea currents, in order to measure the environmental impact resulting from oil plumes. This scenario highlights the need to develop current produced water treatment systems in order to increase processing capacity and provide greater efficiency in the removal of dispersed oil and dissolved organic compounds.

In general, in produced water treatment systems from offshore oil and gas production units, the inlet flow (oil, gas and water mixture) coming from the production header is treated in a treatment train consisting of a heat exchanger followed by separators, such as two-phase and three-phase separators and coalescers. Then, the oil, gas and water stream will go to the oil treatment system, gas pipeline and water treatment system, respectively (USEPA, 1996) (WESCHENFELDER et al., 2015) (JIMÉNEZ et al., 2018c). The sum of the water flow and the water extracted from the oil treatment is subjected to a primary treatment, generally consisting of hydrocyclones, followed by a secondary treatment, generally consisting of flotation aimed at removing the oily phase (dispersed droplets and dissolved fraction) from (LI; LEE, (2009); DORES et al., (2012)).

Weschenfelder et al. (2015) presented a configuration of primary oil processing, typically adopted in offshore oil and gas production units. Hydrocyclones are used to accelerate the process of separating solid or oily particles from the liquid stream by using centrifugal force, increasing the sedimentation speed. Floaters, on the other hand, aim at recovering the oil residue through gravitational separation, based on the increase in the difference in densities between the phases (REGO, 2008; ROCHA, 2018).

However, these conventional equipment are, in most cases, incapable of removing suspended particles with particle size below 5.0 μm, and they rarely achieve the water quality required for reinjection (in terms of suspended solids and O&G content) or industrial processes (LI; LEE, (2009); DORES et al., (2012)). This limits the overall treatment efficiency and impairs the maintenance of the current processing capacity of produced water for disposal.

In this scenario, the liquid-liquid extraction process, carried out with pH reduction (acidification), has proven to be a viable solution for water treatment on some Petrobras platforms that have primary oil processing plants. In these cases, the acid injection occurs in the production header and the oil itself, in a turbulent regime, has the role of promoting the migration of the dissolved organic acids from the produced water, by altering the balance between the oil/water phases present in the system.

However, the acidification step, when carried out in the production header, requires high acid consumption to promote the desired pH reduction, since the oil also consumes the acid, in addition to causing damage to the integrity of the units, due to possible corrosion in equipment and pipelines. This strategy entails high costs and logistical and safety problems in offshore units due to the storage of large quantities of strong acids (hazardous chemical products) in a location with limited storage capacity.

In this way, it is clear that conventional systems for treating produced water need to be improved to ensure that produced water complies with the limits stipulated in the relevant legislation. The addition of large amounts of acid to the production header, despite helping in this process, causes damage to the integrity of offshore installations. Thus, the proposed treatment system, which will be detailed below, aims at providing greater efficiency and consequently increase the treatment capacity of produced water without the need for a larger area or new inputs and equipment. In addition, it reduces the environmental impact of disposing of produced water, since a considerable amount of dissolved hazardous components is transferred from the aqueous phase to the oily phase.

### STATE OF THE ART

Some documents of the state of the art describe processes for treating produced water generated during oil and gas exploration, such as:

Document U.S. Pat. No. 4,818,410 (D1) refers to a process for removing organic substances from oil dissolved in aqueous streams. Such aqueous streams include oil well production fluids from which the oil has been primarily separated and aqueous streams used in the extraction of inorganic salts, such as sodium chloride, from oils in order to make such oils suitable for subsequent refining or for burning in gas turbine plants or processing in other equipment where the presence of inorganic salts is undesirable. The oil processing water to which the present invention applies may contain dissolved a small amount, e.g., 100-1000 ppm or more, of oil organic compounds. Firstly, the pH of the oil processing water is adjusted to within the range of about 2 to 6, preferably to the range of 3 to 5 by incorporating a strong acid, e.g., hydrochloric acid or sulfuric acid. Other strong, organic or inorganic, acids may be used. The pH adjustment may be made to a suitable oil/water mixture or to a previously acidified aqueous stream. Secondly, during or after pH adjustment, the oil-processed water comes into intimate contact with the oil, resulting in a substantial reduction in the water-soluble organic matter content in the oil-processed water, as it is transferred from the water to the oil. Finally, the oil is separated from the oil-processed water. However, it is noted in the aforementioned document that the acidification is performed after the water-oil separation process, which reduces acid consumption in the process by 10% to 40% (depending on the water/oil fraction at the production point). In addition, it induces the insertion of acid into a mixer or into the aqueous stream of a separator vessel. In the present invention, the insertion of the aqueous stream with acid occurs after the separator vessel, in the production header in the PW (produced water) stream before the mixer and the hydrocyclone.

Document U.S. Pat. No. 4,839,054 (D2) refers to a process for removing water-soluble organic matter from produced water. The process comprises: acidifying the produced water with acid; contact of acidified water with a free oil to form a mixture; agitation of the mixture to produce a completely mixed phase; and separation of the phase to produce a free oil phase and a clean water phase. However, in the present invention, the process steps are changed with a new acid addition point and inclusion of a recycle step of the previously treated PW. In addition, it consists of reducing organic compounds in the produced water, which have 40-400 ppm dissolved, wherein the abatement is done in 3 phases: 1) use of acid to reduce solubility; 2) mixing the acidic water with crude oil of API 22 to 35 to form a mixture; 3) agitation to produce coalescence and emulsions; 4) separation of the mixed phase producing a crude oil stream with a greater portion of organic compounds and thus a produced water with a lower content of these compounds. It is noted that the details of the location of the acid addition point and the inclusion of a recycle line for the acidified and previously treated PW (coming from the hydrocyclone outlet), which will drastically reduce acid consumption, are not mentioned in the aforementioned document, highlighting the novelty of the present invention.

U.S. Pat. No. 5,853,592 (D3) relates to a process for the removal of organic and biogenic substances from oil dissolved in aqueous streams. Such aqueous streams include oil well production fluids from which the oil has been mainly separated and aqueous streams used in the extraction of inorganic salts, such as sodium chloride, from oils in order to make such oils suitable for subsequent refining or for burning in gas turbine plants or processing in other equipment where the presence of inorganic salts is undesirable. The oil processing water to which the present invention applies may contain dissolved a small amount, for example, 50-1,000 ppm or more, of oil organic compounds. It is noted in the present invention that, after the hydrocyclone, part of the PW returns to the production header, which causes the acid consumption in the process to be reduced by 10% to 40% (depending on the water/oil fraction at the production point), a process that is not mentioned in the aforementioned document, evidencing the novelty of the present invention.

The document in the name of Klemz et al., titled “Oilfield produced water treatment by liquid-liquid extraction: A review” reviews the removal of soluble organic compounds from water produced in oil fields by liquid-liquid extraction. The novelty of each extraction method is highlighted and possible applications in the oil industry are identified. The use of the C-Tour process is also mentioned, a patented technology that is based on the use of natural gas liquid collected from the production stream itself, as a solvent to extract the dispersed and produced hydrocarbon from the produced water. However, a minimum CV for operation of the static mixer is specified in this document. This is a literature review on the treatment of water produced in oil fields by different processes, with greater emphasis on the liquid-liquid extraction process. The advantages and disadvantages of different treatment methods are presented throughout the document. Since this is a review, the work presents what is available in the literature. However, it is clear that none of the cited papers mentions a change in the injection point of the acid in the produced water treatment stream, nor the use of acidified produced water recycle (after the liquid-liquid extraction process) to the production header, nor any mixing index for greater efficiency of the liquid-liquid extraction process, as proposed in the present invention.

The document in the name of Klemz, titled “Remoção de compostos orgânicos solúveis de água produzida de petróleo por extração líquido-líquido em um misturador-decantador à inversão de fases” (“Removal of soluble organic compounds from oil produced water by liquid-liquid extraction in a phase inversion mixer-decanter”), investigates the removal of soluble organic compounds from produced water through the liquid-liquid extraction process in a phase inversion mixer-decanter. This equipment has the great advantage over conventional separators of being vertically arranged, which takes up little space in industrial units, with high phase separation efficiency. In addition, aiming at facilitating the operational logistics and reduce process costs, the present study investigated the possibility of using a fluid stream collected on the oil extraction platform itself as an extraction solvent. Furthermore, the aforementioned document explores the possibility of using a fluid stream prepared with commercial solvents, composed of 14% n-pentane, 30% n-hexane and 56% n-heptane, simulating the condensate generated on the oil extraction platform itself as an extracting solvent. The use of this fluid stream from the platform in liquid-liquid extraction is also widely known in the state of the art.

It is observed that the efficiency of this methodology was evaluated using synthetic effluent and real effluent initially in a batch system, from which the main parameters that influence the efficiency of the process were identified and the optimal conditions for the implementation of the continuous system were selected, but focused on the liquid-liquid extraction process in a phase inversion mixer-decanter. The results indicated that the lower the pH, the greater the removal efficiency, and for the real effluent evaluated, it was observed that, at pH≤4, this process (liquid-liquid extraction in a phase inversion mixer-decanter) is sufficient to bring the real effluent into compliance with Brazilian disposal standards with only one extraction step. However, unlike the present invention, in D5 it was proposed that acidification should occur in the stream that will be sent to the phase inversion mixer-decanter. In the present invention, in turn, a change in the acid addition point in the produced water stream is proposed, which provides a reduction in acid consumption. Furthermore, the present invention foresees the inclusion of a recycle line for treated produced water, aiming at an even greater reduction in acid consumption and an increase in the efficiency of WSO (water soluble organics) removal, which is not mentioned in the aforementioned document.

The document on behalf of Rye et al., titled “The “Environment Impact Factor” (EIF) for produced water discharges—a tool for reducing environmental impacts” shows the application of a potential impact indicator of the release of produced water in five treatment processes, aiming at selecting the best option to reduce the potential impact of produced water and they conclude that the C-Tour process appears to be one of the most attractive options to reduce environmental impact in an economical way. Such a process is based on the addition of liquid fractions of natural gas to the produced water. However, apparently, such a document only concerns C-Tour and injection for oil recovery. It does not suggest anything that was implemented in the present invention, only the similarity in the use of NGL.

### SUMMARY OF THE INVENTION

The present invention aims at proposing a new flowchart for the treatment process of produced water in offshore oil production facilities. It is further noted that another objective of the present invention is to reduce acid consumption by changing its injection point and promoting an intimate mixing between the acid and the produced water. This is followed by the injection of natural gas liquid (NGL), generated in the offshore installation itself, into the acidified produced water stream to extract the dissolved organic acids. In this way, the NGL is separated from the produced water using conventional separation technology, such as a hydrocyclone. The waste from this unit is sent, together with the extracted oil, to the raw process line that leaves the separators, and a fraction (90% to 50%) of the acidified water goes to the floater and the remainder (10% to 50%) goes through the recycle line to the production header inlet.

### BRIEF DESCRIPTION OF THE FIGURES

FIG. 1 represents the main arrangement of the system/process proposed in the present invention, generating an increase in efficiency in the treatment of PW with reduction of WSO.

FIG. 2 shows images of the phase separation of the liquid-liquid extraction using a) 0% NGL, b) 1% NGL, c) 1% NGL and 200 mg. L⁻¹ HCl and d) 1% NGL and 400 mg. L⁻¹ HCl.

### DETAILED DESCRIPTION OF THE INVENTION

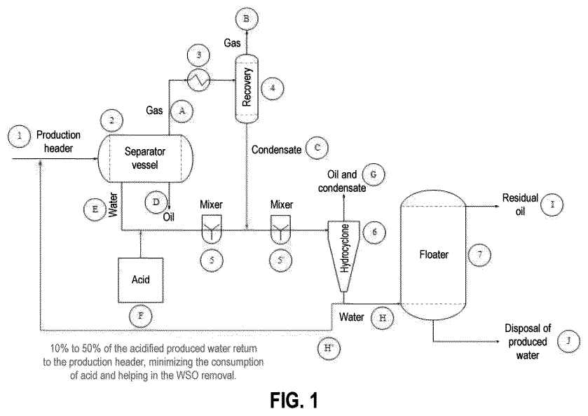

The present invention relates to a system and process for treating water produced in offshore oil production facilities (FIG. 1).

It is verified that oil produced by several wells is collected in a production header (1), which is sent for primary oil separation treatment, being first sent to a separator vessel (2), preferably of the three-phase type, where the gas (A) that comes out at the upper part is cooled by an exchanger (3) and subsequently sent to a recovery vessel (4), which produces dry gas (B) and NGL oily condensate (C); wherein the oil (D) is sent to the raw process line and the produced water (E) that leaves the lower part of the separator vessel (2) receives acid (F) added, passes through two mixers (5.5′) and is sent to a hydrocyclone (6) for liquid-liquid/liquid-solid separation, in which a fraction (90% to 50%) of the water produced in the hydrocyclone (H) is taken to a floater (7) in which residual oil (I) can be extracted from the waste water (J), and the remainder of the produced water (10% to 50%) returns (H′) to the inlet of the production header.

Thus, the proposed process comprises the following steps:
(a) Injection of acid at a point (F) after the separator vessel (2), in order to minimize the consumption of acid necessary to promote the reduction of the pH of the produced water. Batch tests suggest that for a sample containing a water/oil ratio of 50/50, there was an increase of approximately 40% in acid consumption to reduce the pH from 8.6 to 5.0 when compared to a sample containing only produced water. An increase of approximately 12% in acid consumption was observed when using a sample containing a water/oil ratio of 70/30, showing that the presence of oil in the mixture increases acid consumption;
(b) Injection of NGL condensate stream (C) from the recovery vessel (4) as an extracting solvent immediately after the injection of acids (F) into the produced water stream (E), and prior to the separation steps, promoting the migration of dissolved organic acids present in the produced water by altering the equilibrium between the oil/water phases present in the system. The injection of NGL condensate (C) must be carried out between two mixers (5 and 5′). Alternatively, the injection of NGL condensate (6) can be carried out at an intermediate point of a mixer (8) or alternatively between two mixers (8′).
(c) Inclusion of mixers (5, 5′). In addition to the mixing promoted by the passage of fluids through the pipes, install mixers in order to increase the efficiency of intimate mixing between the fluids (aqueous phase and organic phase) and consequently remove the species contributing to the OGC of the produced water. A static mixer (5) must be included after the acidification step, which will promote effective mixing of the acid in the produced water stream, and a static mixer (5′) after the addition of the NGL, which will promote effective mixing of this fluid in the acidified produced water stream.
(d) Inclusion of an acidified produced water recycle step (H′). The mixture of acidified produced water with NGL must be sent to the hydrocyclone separation step (6). Approximately 30 to 50% of the produced water (H) separated by the hydrocyclone must be bled and returned to the production header (1) through a recycle line (H′).

It can be ascertained that the proposed process has the great advantage of facilitating logistics, since the oil industry can use this byproduct (NGL) as an extracting solvent, as well as take advantage of the platform's facilities to include the modifications proposed in this invention and obtain greater efficiency in the PW treatment steps.

By using a stream from the production line itself as a solvent, the technique can be inserted as a step prior to passing through the hydrocyclone (commonly used to separate oil droplets present in water), for example, and thus remove contaminants.

In this scenario, the gas generated on the platform, for example, can be condensed and used as an extracting solvent and subsequently regenerated or discarded in the processing line. And since the acid injection that is currently made into the production header is now carried out at a point (F) downstream of the separator vessel, the entire amount of oil removed in this step will not come into contact with the acid, drastically minimizing the volume required for acidification of the aqueous stream. Likewise, the suggested optimum conditions (pH=5.7) take into account the preservation of the pipelines against corrosion and the safety of the platforms.

Furthermore, in order to improve the homogenization of the produced water with the acid and the NGL, and consequently increase the oil and grease (O&G) removal capacity, different mixing devices can be added to the treatment line.

Said system comprises the following components and/or steps:
at least one production header (1);
at least one separator vessel capable of separating the oil, water and gas (2);
an exchanger (3) in the line that interconnects the separator vessel (2) and the recovery vessel (4);
a recovery vessel (4) capable of separating gas (vapor) from the natural gas liquid NGL;
a line leaving the separator vessel of the produced water stream (E);
an acid injection point (F) in the produced water stream line (E);
at least one mixer (5) which receives the water stream produced with the acid;
at least one mixer (5′) which receives the water stream produced and acidified with the extracting solvent;
at least one hydrocyclone (6) of the liquid-liquid type. Optionally, the system may comprise a series of hydrocyclones connected in parallel and/or in series, each of which may be of the liquid-liquid, solid-liquid or gas-liquid type;
a recycle line (H′) of the produced water stream (H) after the hydrocyclone (6);
a point for injection of chemical products into the produced water line (H), immediately after the bleed point of the recycle line;
optionally a mixer which receives the produced water (H) with chemical products (flocculants);
a floater (7) containing a line for disposal of treated produced water (J) and a line for upper extraction of residual oil (I).

The produced water treatment system described by the invention is characterized by the replacement of the acid injection point and injection of NGL prior to the separation steps (hydrocyclones and floaters). Further, the invention describes the different alternatives for promoting the mixing of these inputs in the produced water stream, being adaptable to equipment and units already in operation and without the need to acquire new chemical products and equipment.

This invention also describes the presence of a recycle line for acidified produced water coming from the hydrocyclone outlet to the production header inlet. This recycle line has the function of lowering the pH of the mixture in the three-phase separator (this pH reduction depends on the recycle ratio used) providing a reduction in acid consumption and an increase in the WSO removal efficiency.

### Examples and Results of the Invention

Both the process and the system proposed in the present invention were tested through experimental tests using as an initial sample the produced water collected at the beginning of the process (production header). Liquid-liquid extraction tests using natural gas liquid (NGL) as the extracting fluid were performed in batch mode.

Experimental batch tests indicate that, for a sample containing a water/oil ratio of 50/50, there was an increase of approximately 40% in acid consumption to reduce the pH from 8.6 to 5.0, when compared to a sample containing only produced water. An increase of approximately 12% in acid consumption was observed when using a sample containing a water/oil ratio of 70/30.

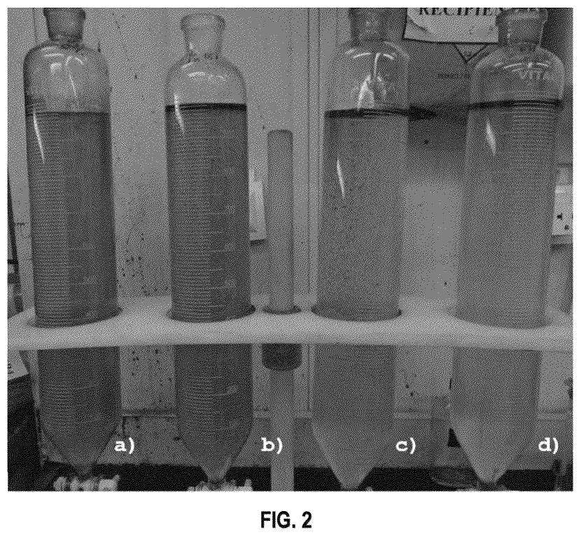

The experimental procedure involved the steps of collecting the volume of produced water; adding HCl (when necessary); adding the volume of NGL in the proportion defined for the test (18); manual agitation; and complete separation of the phases (FIG. 2). Next, the OGC of the aqueous phase was evaluated using the standard analytical methodology SM 5520B (gravimetric method). Briefly, this technique consists of subjecting the sample (1 L at pH 2.0) to a sequence of three extractions, with aliquots of 30 mL of n-hexane each.

After the extraction, the organic phase is collected in a previously weighed boiling flask and distilled at 85° C. and subjected to new weighing. With the determined masses and volume of the sample, it becomes possible to determine the concentration of oils and greases, in units of mass per volume (mg. L⁻¹). Initially, the OGC and pH of the initial sample (blank) were measured, and the sample was then placed in contact with 1% NGL with and without the addition of acid. The results obtained are presented in Table 1.

TABLE 1
Results of the extraction test using NGL as the
extracting fluid with and without the acidification step.

| | | OGC-Gravimetric | OGC-Gravimetric |
|---|---|---|---|
| | | (SM 5520B) | (SM 5520B) |
| | | acid addition at | acid addition |
| | | the production | AFTER the |
| Samples | pH | header | production header |
| Blank-0% NGL | 8.1 | 77 mg · L⁻¹ | 77 mg · L⁻¹ |
| 1% NGL | 8.1 | — | 58 mg · L⁻¹ |
| 1% NGL + 200 mg · L⁻¹ HCl | 6.8 | ~69 mg · L⁻¹ | 36 mg · L⁻¹ |
| 1% NGL + 400 mg · L⁻¹ HCl | 5.7 | ~46 mg · L⁻¹ | 29 mg · L⁻¹ |

The OGC of the initial sample (blank) was 77 mg. L⁻¹ and the recorded pH was 8.1. The inclusion of a pre-treatment by liquid-liquid extraction (without acidification of the produced water) allowed the reduction of approximately 25% of the initial OGC, but still makes it impossible to dispose of it at sea.

However, evaluating the injection and mixture of acid (acidification of the produced water) and 1% of natural gas liquid (NGL), it allowed the reduction of 53 and 62% of the initial OGC when 200 and 400 mg. L⁻¹ of HCl were added, respectively. In the experiments carried out at pH 5.7 (addition of 400 mg. L⁻¹ of HCl) and with the addition of 1% of NGL, it was possible to obtain an effluent with characteristics suitable for disposal as stipulated by CONAMA legislation No. 393, demonstrating the efficiency of the proposed treatment.

This behavior can be explained by considering that pH is directly related to the solubility of acids in the organic phase, through the balance of protonation and deprotonation of the acids. As previously discussed, at low pH, the solubility of organic acids in the organic phase is reduced through the balance of protonation and deprotonation of the acid. In the protonated form, they have high solubility in the aqueous phase, making their extraction difficult, which is why the O&G removal results were lower at pH 8.1 and 6.8 compared to pH 5.7.

### Advantages Achieved by the Present Invention

The water treatment process and system proposed in the present invention have the following advantages:

### Economy/Productivity

The economy of the treatment process is obtained by reducing the consumption of acid required for acidification of the produced water and consequently for removal of dissolved organic compounds. In addition to increasing the treatment capacity of existing facilities, the process allows for increased oil production and greater equipment integrity (pumps, hydrocyclone, pipes and tanks).

### Environmental

The present invention aims at reducing the quantity of certain species that contribute to the OGC of produced water, aiming not only at achieving discharge standards, but also to dispose of increasingly purified streams at sea in order to ensure the preservation of the quality of the receiving water body.

### Other Advantages

The proposed invention is adaptable to equipment and units already in operation and without the need to acquire new chemical products.

### Reliability

The disposal of increasingly purified streams at sea will allow the company to strategically position itself, given the even more severe restrictions that may be imposed on the disposal of the produced water, in future revisions of current legislation. In this way, the proposed invention will bring, at a national level, technical advances in the treatment systems of produced water from the production operations of the company in the oil and natural gas sector, with a consecutive increase in economic and financial performance and mitigation of the environmental impacts.

1. A process for water treatment in offshore oil production facilities comprising:
(a) injecting acid into produced water after a separator vessel;
(b) injecting natural gas liquid (NGL) condensate stream from a recovery vessel as an extracting solvent immediately after injecting acids into the produced water stream;
(c) including at least two mixers before acidifying the produced water and another after adding the extracting solvent before being sent to a hydrocyclone separation step; and
(d) separating and/or bleeding approximately 10 to 50% of the produced water from at least one hydrocycloneand returning to a production header via a recycle line.

2. The process according to claim 1, wherein the injection of NGL condensate is carried out between two mixers.

3. The process according to claim 1, wherein the injection of acid into the produced water after the separator vessel and the recycle line of the treated produced water reduces a consumption of acid and a pH of the produced water, increasing an efficiency of water soluble organics removal.

4. The process according to claim 1, wherein a sample containing 1% NGL and 400 mg. L⁻¹ HCl, at pH 5.7, reduced an initial gravimetric OGC of the produced water by 62%.

5. The process according to claim 1, wherein the injection of acid occurs directly into the production header as a complement to the recycle line.

6. A system for water treatment in offshore oil production facilities, comprising:
at least one production header;
at least one separator vessel capable of separating oil, water, and gas;
an exchanger in a line that interconnects the separator vessel and a recovery vessel;
the recovery vessel capable of separating gas from natural gas liquid NGL;
a line leaving the separator vessel of a produced water stream;
an acid injection point in a produced water stream line;
at least one mixer which receives a produced water stream with the acid;
at least one mixer which receives the produced water stream acidified with an extracting solvent;
at least one hydrocyclone of a liquid-liquid type;
a recycle line of the acidified produced water stream after the at least one hydrocyclone; and
a floater containing a line for disposal of treated produced water and a line for upper extraction of residual oil.

7. The system according to claim 6, further comprising a series of hydrocyclones connected in parallel and/or in series, each of which is of the liquid-liquid type, a solid-liquid type, or a gas-liquid type.

8. The system according to claim 6, wherein the recycle line is bled from 10% to 50% of a volumetric flow of produced water after the hydrocyclone.

9. The system according to claim 6, wherein the at least one production header receives the gas-water-oil mixture, and also the acidified produced water coming from a hydrocyclone outlet.

10. System according to claim 6, wherein the recycle line has an effect of lowering a pH of the mixture in the separator, reducing acid consumption and increasing an efficiency of water soluble organics removal.

11. The system according to claim 6, wherein there is an injection point of chemical products in the produced water line, immediately after a bleeding point of the recycle line.

12. The system according to claim 11, wherein there is a mixer which receives the produced water with flocculants.
